(19) United States
(12) Patent Application Publication
(10) Pub. No.: US 2012/0212810 A1
(43) Pub. Date: Aug. 23, 2012

(54) MIRROR FOR THE EUV WAVELENGTH RANGE, PROJECTION OBJECTIVE FOR MICROLITHOGRAPHY CROMPRISING SUCH A MIRROR, AND PROJECTION EXPOSURE APPARATUS FOR MICROLITHOGRAPHY COMPRISING SUCH A PROJECTION OBJECTIVE

(75) Inventors: Hans-Jochen Paul, Aalen (DE); Gerhard Braun, Ederheim (DE); Sascha Migura, Aalen-Unterrombach (DE); Aurelian Dodoc, Heidenheim (DE); Christoph Zaczek, Heubach (DE)

(73) Assignee: CARL ZEISS SMT GMBH, Oberkochen (DE)

(21) Appl. No.: 13/347,431

(22) Filed: Jan. 10, 2012

Related U.S. Application Data
(63) Continuation of application No. PCT/EP2010/057655, filed on Jun. 1, 2010.
(60) Provisional application No. 61/224,710, filed on Jul. 10, 2009.

(30) Foreign Application Priority Data
Jul. 10, 2009 (DE) 10 2009 032 779.7

(51) Int. Cl. G02B 5/08

(52) U.S. Cl. 359/360; 359/359

(57) ABSTRACT

EUV-mirror having a substrate (S) and a layer arrangement that includes plural layer subsystems (P″, P′″) each consisting of a periodic sequence of at least two periods (P₂, P₃) of individual layers. The periods (P₂, P₃) include two individual layers composed of different materials for a high refractive index layer (H″, H′″) and a low refractive index layer (L″, L′″) and have within each layer subsystem (P″, P′″) a constant thickness (d₂, d₃) that deviates from that of the periods of an adjacent layer subsystem. In one alternative, the layer subsystem (P″) second most distant from the substrate has a period sequence (P₂) such that the first high refractive index layer (H′″) of the layer subsystem (P′″) most distant from the substrate directly succeeds the last high refractive index layer (H″) of the layer subsystem (P″) second most distant from the substrate

### CROSS REFERENCE TO RELATED APPLICATIONS

This is a Continuation of International Application PCT/EP2010/057655, with an international filing date of Jun. 1, 2010, which was published under PCT Article 21(2) in English, and which claims priority under 35 U.S.C. §119(a) to German Patent Application No. 10 2009 032 779.7, filed on Jul. 10, 2009, and to U.S. Provisional Application No. 61/224,710, also filed on Jul. 10, 2009. The entire contents of each of these applications are hereby incorporated by reference.

### FIELD OF AND BACKGROUND OF THE INVENTION

The invention relates to a mirror for the extreme-ultraviolet (EUV) wavelength range. Furthermore, the invention relates to a projection objective for microlithography comprising such a mirror. Moreover, the invention relates to a projection exposure apparatus for microlithography comprising such a projection objective.

Projection exposure apparatuses for microlithography for the EUV wavelength range have to rely on the assumption that the mirrors used for the exposure or imaging of a mask into an image plane have a high reflectivity since, firstly, the product of the reflectivity values of the individual mirrors determines the total transmission of the projection exposure apparatus and since, secondly, the light power of EUV light sources is limited.

Mirrors for the EUV wavelength range around 13 nm having high reflectivity values are known from DE 101 55 711 A1, for example. The mirrors described therein consist of a layer arrangement which is applied on a substrate and which has a sequence of individual layers, wherein the layer arrangement comprises a plurality of layer subsystems each having a periodic sequence of at least two individual layers of different materials that form a period, wherein the number of periods and the thickness of the periods of the individual subsystems decrease from the substrate toward the surface. Such mirrors have a reflectivity of greater than 30% in the case of an angle of incidence interval of between 0° and 20°.

In this case, the angle of incidence is defined as the angle between the direction of incidence of a light ray and the normal to the surface of the mirror at the point where the light ray impinges on the mirror. In this case, the angle of incidence interval results from the angle interval between the largest and the smallest angle of incidence respectively considered for a mirror.

### OBJECTS AND SUMMARY OF THE INVENTION

What is disadvantageous about the abovementioned layers, however, is that their reflectivity in the angle of incidence interval specified is not constant, but rather varies. A variation of the reflectivity of a mirror over the angles of incidence is disadvantageous, however, for the use of such a mirror at locations with high angles of incidence and with high angle of incidence changes in a projection objective for microlithography since such a variation leads for example to an excessively large variation of the pupil apodization of such a projection objective. In this case, the pupil apodization is a measure of the intensity fluctuation over the exit pupil of a projection objective.

It is an object of the invention to provide a mirror for the EUV wavelength range which can be used at locations with high angles of incidence and high angle of incidence change within a projection objective or projection exposure apparatus.

This object is achieved according to one formulation of the invention by a mirror for the EUV wavelength range comprising a substrate and a layer arrangement, wherein the layer arrangement comprises a plurality of layer subsystems. In this case, the layer subsystems each consist of a periodic sequence of at least two periods of individual layers. In this case, the periods comprise two individual layers composed of different materials for a high refractive index layer and a low refractive index layer and have within each layer subsystem a constant thickness that deviates from a thickness of the periods of an adjacent layer subsystem. In this case, the layer subsystem that is second most distant from the substrate has a sequence of the periods such that the first high refractive index layer of the layer subsystem that is most distant from the substrate directly succeeds the last high refractive index layer of the layer subsystem that is second most distant from the substrate and/or the layer subsystem that is most distant from the substrate has a number of periods that is greater than the number of periods for the layer subsystem that is second most distant from the substrate.

In this case, the layer subsystems of the layer arrangement of the inventive mirrorsucceed one another directly and are not separated by a further layer system. Furthermore, in the context of the present application, a layer subsystem is distinguished from an adjacent layer subsystem, even given otherwise identical division of the periods between high and low refractive index layers, if a deviation by more than 0.1 nm is present as deviation in the thickness of the periods of the adjacent layer subsystems since, starting from a difference of 0.1 nm, it is possible to assume a different optical effect of the layer subsystems with otherwise identical division of the periods between high and low refractive index layers.

The terms high refractive index and low refractive index are in this case, in the EUV wavelength range, relative terms with regard to the respective partner layer in a period of a layer subsystem. In the EUV wavelength range, layer subsystems generally function only if a layer that acts with optically high refractive index is combined with an optically lower refractive index layer relative thereto as main constituent of a period of the layer subsystem.

It has been recognized by the inventors that in order to achieve a high and uniform reflectivity across a large angle of incidence interval, the number of periods for the layer subsystem that is most distant from the substrate must be greater than that for the layer subsystem that is second most distant from the substrate. Furthermore it has been recognized that, in order to achieve a high and uniform reflectivity across a large angle of incidence interval, as an alternative or in addition to the measure mentioned above, the first high refractive index layer of the layer subsystem that is most distant from the substrate should directly succeed the last high refractive index layer of the layer subsystem that is second most distant from the substrate.

Furthermore according to another formulation, the object of the invention is achieved by a mirror for the EUV wavelength range comprising a substrate and a layer arrangement, wherein the layer arrangement comprises a plurality of layer subsystems. In this case, the layer subsystems each consist of a periodic sequence of at least two periods of individual layers. In this case, the periods comprise two individual layers composed of different materials for a high refractive index layer and a low refractive index layer and have within each layer subsystem a constant thickness that deviates from a thickness of the periods of an adjacent layer subsystem. In this case, the layer subsystem that is second most distant from the substrate has a sequence of the periods such that the first high refractive index layer of the layer subsystem that is most distant from the substrate directly succeeds the last high refractive index layer of the layer subsystem that is second most distant from the substrate. Furthermore, the transmission of EUV radiation through the layer subsystems amounts to less than 10%, in particular less than 2%.

It has been recognized by the inventors that, in order to achieve a high and uniform reflectivity across a large angle of incidence interval, the influence of layers situated below the layer arrangement or of the substrate must be reduced. This is necessary primarily for a layer arrangement in which the layer subsystem that is second most distant from the substrate has a sequence of the periods such that the first high refractive index layer of the layer subsystem that is most distant from the substrate directly succeeds the last high refractive index layer of the layer subsystem that is second most distant from the substrate. One simple possibility for reducing the influence of layers lying below the layer arrangement or of the substrate consists in designing the layer arrangement such that the latter transmits as little EUV radiation as possible to the layers lying below the layer arrangement. This ill affords the possibility for said layers lying below the layer arrangement or the substrate to make a significant contribution to the reflectivity properties of the mirror.

In one embodiment, the layer subsystems are in this case all constructed from the same materials for the high and low refractive index layers since this simplifies the production of mirrors.

A mirror for the EUV wavelength range in which the number of periods of the layer subsystem that is most distant from the substrate corresponds to a value of between 9 and 16, and a mirror for the EUV wavelength range in which the number of periods of the layer subsystem that is second most distant from the substrate corresponds to a value of between 2 and 12, lead to a limitation of the layers required in total for the mirror and thus to a reduction of the complexity and the risk during the production of the mirror.

In a further embodiment, the layer arrangement of a mirror comprises at least three layer subsystems, wherein the number of periods of the layer subsystem that is situated closest to the substrate is greater than for the layer subsystem that is most distant from the substrate and/or is greater than for the layer subsystem that is second most distant from the substrate.

These measures foster a decoupling of the reflection properties of the mirror from layers lying below the layer arrangement or the substrate, such that it is possible to use other layers with other functional properties or other substrate materials below the layer arrangement of the mirror.

Firstly, it is thus possible, as already mentioned above, to avoid perturbing effects of the layers lying below the layer arrangement or of the substrate on the optical properties of the mirror, and in this case in particular on the reflectivity, and, secondly, it is thereby possible for layers lying below the layer arrangement or the substrate to be sufficiently protected from the EUV radiation.

In a further embodiment, such protection from EUV radiation, which may be necessary, for example, if the layers lying below the layer arrangement or the substrate do(es) not have long-term stability of the properties thereof under EUV irradiation, in addition or as an alternative to the measures mentioned above, is ensured by a metal layer having a thickness of greater than 20 nm between the layer arrangement and the substrate. Such a protective layer is also referred to as “Surface Protecting Layer”, (SPL).

In this case, it should be taken into consideration that the properties of reflectivity, transmission and absorption of a layer arrangement behave nonlinearly with respect to the number of periods of the layer arrangement; the reflectivity, in particular exhibits a saturation behavior toward a limit value with regard to the number of periods of a layer arrangement. Consequently, the abovementioned protective layer can be used to reduce the required number of periods of a layer arrangement for the protection of the layers lying below the layer arrangement or of the substrate from EUV radiation to the required number of periods for achieving the reflectivity properties.

Furthermore, it has been recognized that it is possible to achieve particularly high reflectivity values for a layer arrangement in the case of a small number of layer subsystems if, in this case, the period for the layer subsystem that is most distant from the substrate has a thickness of the high refractive index layer which amounts to more than 120% of the thickness, in particular more than double the thickness, of the high refractive index layer of the period for the layer subsystem that is second most distant from the substrate.

It is likewise possible to achieve particularly high reflectivity values for a layer arrangement in the case of a small number of layer subsystems in a further embodiment if the period for the layer subsystem that is most distant from the substrate has a thickness of the low refractive index layer which is less than 80%, in particular less than two thirds of the thickness of the low refractive index layer of the period for the layer subsystem that is second most distant from the substrate.

In a further embodiment, a mirror for the EUV wavelength range has, for the layer subsystem that is second most distant from the substrate, a thickness of the low refractive index layer of the period which is greater than 4 nm, in particular greater than 5 nm. As a result of this it is possible that the layer design can be adapted not only with regard to the reflectivity per se, but also with regard to the reflectivity of s-polarized light with respect to the reflectivity of p-polarized light over the angle of incidence interval striven for. Primarily for layer arrangements which consist of only two layer subsystems, the possibility is thus afforded of performing a polarization adaptation despite limited degrees of freedom as a result of the limited number of layer subsystems.

In another embodiment, a mirror for the EUV wavelength range has a thickness of the periods for the layer subsystem that is most distant from the substrate of between 7.2 nm and 7.7 nm. It is thereby possible to realize particularly high uniform reflectivity values for large angle of incidence intervals.

Furthermore, a further embodiment has an intermediate layer or an intermediate layer arrangement between the layer arrangement of the mirror and the substrate, which serves for the stress compensation of the layer arrangement. Utilizing such stress compensation, it is possible to avoid deformation of the mirror during the application of the layers.

In another embodiment of a mirror according to the invention, the two individual layers forming a period consist either of the materials molybdenum (Mo) and silicon (Si) or of the materials ruthenium (Ru) and silicon (Si). It is thereby possible to achieve particularly high reflectivity values and at the same time to realize production engineering advantages since only two different materials are used for producing the layer subsystems of the layer arrangement of the mirror.

In this case, in a further embodiment, said individual layers are separated by at least one barrier layer, wherein the barrier layer consists of a material which is selected from or as a compound is composed of the group of materials: B₄C, C, Si nitride, Si carbide, Si boride, Mo nitride, Mo carbide, Mo boride, Ru nitride, Ru carbide and Ru boride. Such a barrier layer suppresses the interdiffusion between the two individual layers of a period, thereby increasing the optical contrast in the transition of the two individual layers. With the use of the materials molybdenum and silicon for the two individual layers of a period, one barrier layer above the Si layer, as viewed from the substrate, suffices in order to provide for a sufficient contrast. The second barrier layer above the Mo layer can be dispensed with in this case. In this respect, at least one barrier layer for separating the two individual layers of a period should be provided, wherein the at least one barrier layer may perfectly well be constructed from various ones of the above-indicated materials or the compounds thereof and may in this case also exhibit a layered construction of different materials or compounds.

Barrier layers which comprise the material B₄C and have a thickness of between 0.35 nm and 0.8 nm, preferably between 0.4 nm and 0.6 nm, lead in practice to high reflectivity values of the layer arrangement. Particularly in the case of layer subsystems composed of ruthenium and silicon, barrier layers composed of B₄C exhibit a maximum of reflectivity in the case of values of between 0.4 nm and 0.6 nm for the thickness of the barrier layer.

In a further embodiment, a mirror according to the invention comprises a covering layer system comprising at least one layer composed of a chemically inert material, which terminates the layer arrangement of the mirror. The mirror is thereby protected against ambient influences.

In another embodiment, the mirror according to the invention has a thickness factor of the layer arrangement along the mirror surface having values of between 0.9 and 1.05, in particular having values of between 0.933 and 1.018. It is thereby possible for different locations of the mirror surface to be adapted in a more targeted fashion to different angles of incidence that occur there.

In this case, the thickness factor is the factor with which all the thicknesses of the layers of a given layer design, in multiplied fashion, are realized at a location on the substrate. A thickness factor of 1 thus corresponds to the nominal layer design.

The thickness factor as a further degree of freedom makes it possible for different locations of the mirror to be adapted in a more targeted fashion to different angle of incidence intervals that occur there, without the layer design of the mirror per se having to be changed, with the result that the mirror ultimately yields, for higher angle of incidence intervals across different locations on the mirror, higher reflectivity values than are permitted by the associated layer design per se given a fixed thickness factor of 1. By adapting the thickness factor, it is thus also possible, over and above ensuring high angles of incidence, to achieve a further reduction of the variation of the reflectivity of the mirror according to the invention over the angles of incidence.

In a further embodiment, the thickness factor of the layer arrangement at locations of the mirror surface correlates with the maximum angle of incidence that occurs there, since, for a higher maximum angle of incidence, a higher thickness factor is useful for the adaptation.

In a further formulation of the invention, the object is addressed with a projection objective comprising at least one mirror according to the invention.

In a further aspect, the object of the invention is achieved by a projection exposure apparatus for microlithography comprising such a projection objective.

Further features and advantages of the invention will become apparent from the following description of exemplary embodiments of the invention with reference to the figures, and from the claims. The individual features can be realized in each case individually by themselves or in a plurality of combinations, as desired in view of the particular attributes being considered.

### BRIEF DESCRIPTION OF THE DRAWINGS

Exemplary embodiments of the invention are explained in greater detail below with reference to the figures, in which:

FIG. 1 shows a schematic illustration of a first mirror according to the invention;

FIG. 2 shows a schematic illustration of a second mirror according to the invention;

FIG. 3 shows a schematic illustration of a third mirror according to the invention;

FIG. 4 shows a schematic illustration of a projection objective according to the invention for a projection exposure apparatus for microlithography;

FIG. 5 shows a schematic illustration of the image field of the projection objective;

FIG. 6 shows an exemplary illustration of the maximum angles of incidence and the interval lengths of the angle of incidence intervals against the distance of the locations of a mirror according to the invention with respect to the optical axis within a projection objective;

FIG. 7 shows a schematic illustration of the optically utilized region on the substrate of a mirror according to the invention;

FIG. 8 shows a schematic illustration of some reflectivity values against the angles of incidence of the first mirror according to the invention from FIG. 1;

FIG. 9 shows a schematic illustration of further reflectivity values against the angles of incidence of the first mirror according to the invention from FIG. 1;

FIG. 10 shows a schematic illustration of some reflectivity values against the angles of incidence of the second mirror according to the invention from FIG. 2;

FIG. 11 shows a schematic illustration of further reflectivity values against the angles of incidence of the second mirror according to the invention from FIG. 2;

FIG. 12 shows a schematic illustration of some reflectivity values against the angles of incidence of the third mirror according to the invention from FIG. 3;

FIG. 13 shows a schematic illustration of further reflectivity values against the angles of incidence of the third mirror according to the invention from FIG. 3;

FIG. 14 shows a schematic illustration of some reflectivity values against the angles of incidence of a fourth mirror according to the invention; and

FIG. 15 shows a schematic illustration of further reflectivity values against the angles of incidence of the fourth mirror according to the invention.

### DETAILED DESCRIPTION OF PREFERRED EMBODIMENTS

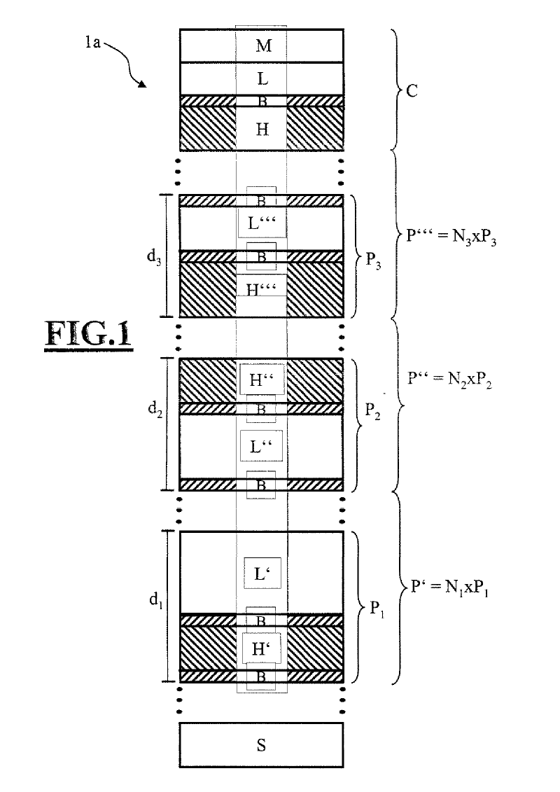

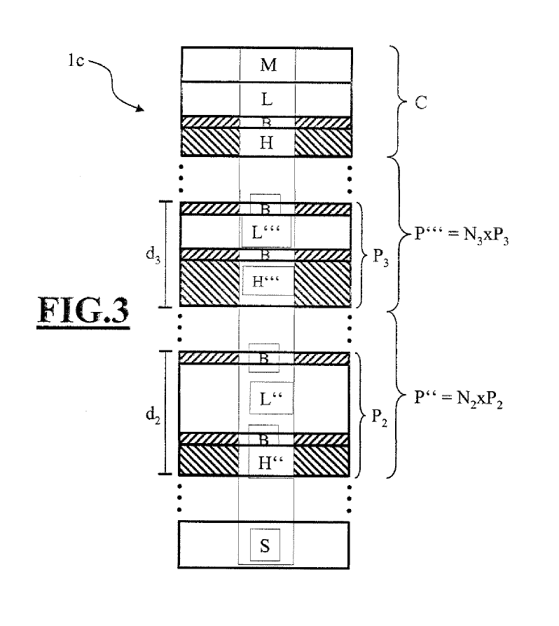

Respective mirrors 1a, 1b and 1c embodying aspects of the invention are described below with reference to FIGS. 1, 2 and 3, the corresponding features of the mirrors bearing the same reference signs in the figures. Furthermore, the corresponding features or properties of these mirrors according to aspects of the invention are explained in summary for FIGS. 1 to 3 below following the description concerning FIG. 3.

FIG. 1 shows a schematic illustration of a mirror 1a according to the invention for the EUV wavelength range comprising a substrate S and a layer arrangement. In this case, the layer arrangement comprises a plurality of layer subsystems P′, P″ and P′″ each consisting of a periodic sequence of at least two periods P₁, P₂ and P₃ of individual layers, wherein the periods P₁, P₂ and P₃ comprise two individual layers composed of different materials for a high refractive index layer H′, H″ and H′″ and a low refractive index layer L′, L″ and L′″ and have within each layer subsystem P′, P″ and P′″ a constant thickness d₁, d₂ and d₃ that deviates from a thickness of the periods of an adjacent layer subsystem. In this case, the layer subsystem P′″ that is most distant from the substrate has a number N₃ of periods P₃ that is greater than the number N₂ of periods P₂ for the layer subsystem P″ that is second most distant from the substrate. In addition, the layer subsystem P″ that is second most distant from the substrate has a sequence of the periods P₂ such that the first high refractive index layer H′″ of the layer subsystem P′″ that is most distant from the substrate directly succeeds the last high refractive index layer H″ of the layer subsystem P″ that is second most distant from the substrate.

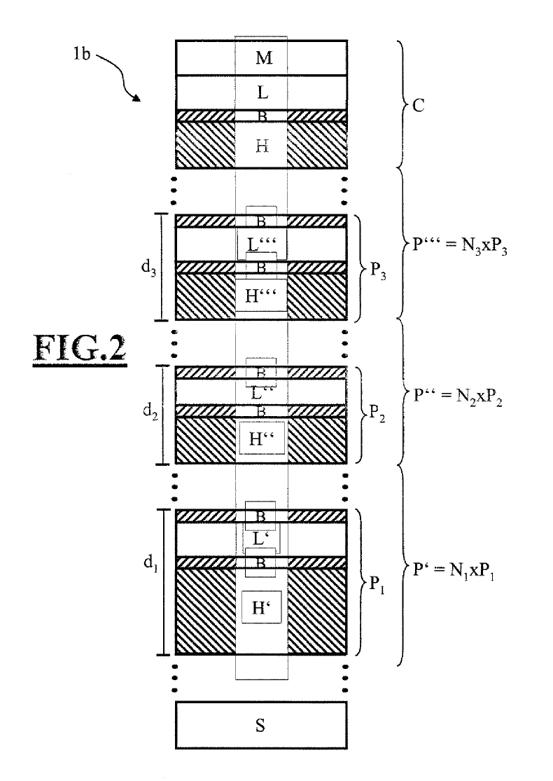

Consequently, in FIG. 1, the order of the high H″ and low refractive index L″ layers within the periods P₂ in the layer subsystem P″ that is second most distant from the substrate is reversed relative to the order of the high H′, H′″ and low refractive index L′, L″ layers within the other periods P₁, P₃ of the other layer subsystems P′, P′″, such that the first low refractive index layer L″ of the layer subsystem P″ that is second most distant from the substrate also optically actively succeeds the last low refractive index layer L′ of the layer subsystem P′ that is situated closest to the substrate. Therefore, the layer subsystem P″ that is second most distant from the substrate in FIG. 1 also differs in the order of the layers from all the other layer subsystems in FIGS. 2 and 3 that are described below.

FIG. 2 shows a schematic illustration of a mirror 1b according to the invention for the EUV wavelength range comprising a substrate S and a layer arrangement. In this case, the layer arrangement comprises a plurality of layer subsystems P′, P″ and P′″ each consisting of a periodic sequence of at least two periods P₁, P₂ and P₃ of individual layers, wherein the periods P₁, P₂ and P₃ comprise two individual layers composed of different materials for a high refractive index layer H′, H″ and H′″ and a low refractive index layer L′, L″ and L′″ and have within each layer subsystem P′, P″ and P′″ a constant thickness d₁, d₂ and d₃ that deviates from a thickness of the periods of an adjacent layer subsystem. In this case, the layer subsystem P′″ that is most distant from the substrate has a number N₃ of periods P₃ that is greater than the number N₂ of periods P₂ for the layer subsystem P″ that is second most distant from the substrate. In this case, unlike in the case of the exemplary embodiment concerning FIG. 1, the layer subsystem P″ that is second most distant from the substrate has a sequence of the periods P₂ which corresponds to the sequence of the periods P₁ and P₃ of the other layer subsystems P′ and P′″, such that the first high refractive index layer H′″ of the layer subsystem P′″ that is most distant from the substrate optically actively succeeds the last low refractive index layer L″ of the layer subsystem P″ that is second most distant from the substrate.

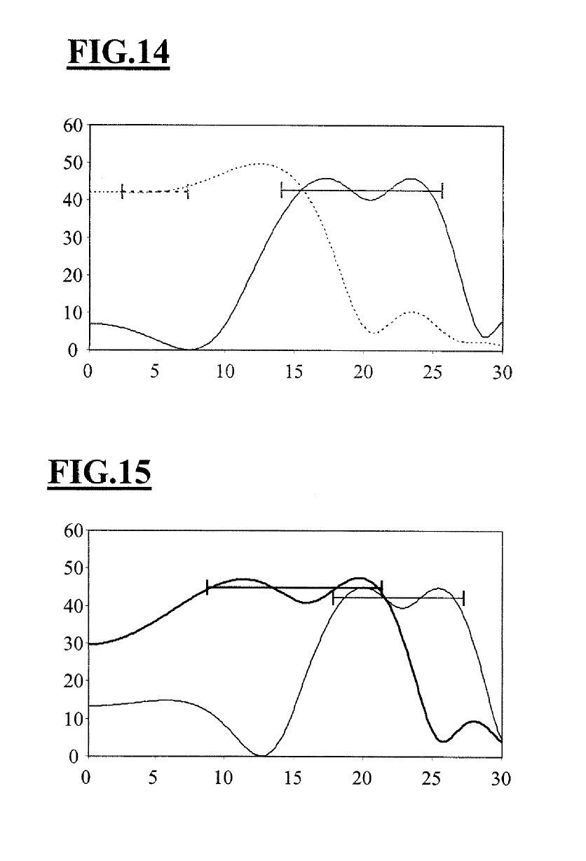

FIG. 3 shows a schematic illustration of a further mirror 1c according to the invention for the EUV wavelength range comprising a substrate S and a layer arrangement. In this case, the layer arrangement comprises a plurality of layer subsystems P″ and P′ each consisting of a periodic sequence of at least two periods P₂ and P₃ of individual layers, wherein the periods P₂ and P₃ comprise two individual layers composed of different materials for a high refractive index layer H″ and H′″ and a low refractive index layer L″ and L′ and have within each layer subsystem P″ and P′ a constant thickness d₂ and d₃ that deviates from a thickness of the periods of an adjacent layer subsystem. In this case, in a fourth exemplary embodiment in accordance with the description concerning FIGS. 14 and 15, the layer subsystem P′″ that is most distant from the substrate has a number N₃ of periods P₃ that is greater than the number N₂ of periods P₂ for the layer subsystem P″ that is second most distant from the substrate. This fourth exemplary embodiment also comprises, as a variant with respect to the illustration of the mirror 1c in FIG. 3 corresponding to mirror 1a, the reversed order of the layers in the layer subsystem P″ that is second most distant from the substrate S, such that this fourth exemplary embodiment also has the feature that the first high refractive index layer H′″ of the layer subsystem P′ that is most distant from the substrate optically actively succeeds the last low refractive index layer L″ of the layer subsystem P″ that is second most distant from the substrate.

Particularly in the case of a small number of layer subsystems, for example, just two layer subsystems it is found that high reflectivity values are obtained if the period P₃ for the layer subsystem P′″ that is most distant from the substrate has a thickness of the high refractive index layer H′ which amounts to more than 120% of the thickness, in particular more than double the thickness, of the high refractive index layer H″ of the period P₂ for the layer subsystem P″ that is second most distant from the substrate.

The layer subsystems of the layer arrangement of the mirrors according to the invention with respect to FIGS. 1 to 3 succeed one another directly and are not separated by a further layer system. However, separation of the layer subsystems by an individual intermediate layer is conceivable for adapting the layer subsystems to one another or for optimizing the optical properties of the layer arrangement. This last does not apply, however, to the two layer subsystems P″ and P′″ of the first exemplary embodiment with respect to FIG. 1 and the fourth exemplary embodiment as a variant with respect to FIG. 3 since the desired optical effect would thereby be prevented by the reversal of the sequence of the layers in P″.

The layers designated by H, H′, H″ and H′″ in FIGS. 1 to 3 are layers composed of materials which, in the EUV wavelength range, can be designated as high refractive index layers in comparison with the layers of the same layer subsystem which are designated as L, L′, L″ and L′, see the complex refractive indices of the materials in table 2. Conversely, the layers designated by L, L′, L″ and L′″ in FIGS. 1 to 3 are layers composed of materials which, in the EUV wavelength range, can be designated as low refractive index layers in comparison with the layers of the same layer subsystem which are designated as H, H′, H″ and H′″. Consequently, the terms high refractive index and low refractive index in the EUV wavelength range are relative terms with regard to the respective partner layer in a period of a layer subsystem. Layer subsystems function in the EUV wavelength range generally only if a layer that acts optically with a high refractive index is combined with a layer that optically has a lower refractive index relative thereto, as main constituent of a period of the layer subsystem. The material silicon is generally used for high refractive index layers. In combination with silicon, the materials molybdenum and ruthenium should be designated as low refractive index layers, see the complex refractive indices of the materials in table 2.

In FIGS. 1 to 3, a barrier layer B is in each case situated between the individual layers of a period, either composed of silicon and molybdenum or composed of silicon and ruthenium, said barrier layer consisting of a material which is selected from or as a compound is composed of the group of materials: B₄C, C, Si nitride, Si carbide, Si boride, Mo nitride, Mo carbide, Mo boride, Ru nitride, Ru carbide and Ru boride. Such a barrier layer suppresses the interdiffusion between the two individual layers of a period, thereby increasing the optical contrast in the transition of the two individual layers. With the use of the materials molybdenum and silicon for the two individual layers of a period, one barrier layer above the silicon layer, as viewed from the substrate, suffices in order to provide for a sufficient contrast. The second barrier layer above the molybdenum layer can be dispensed with in this case. In this respect, at least one barrier layer for separating the two individual layers of a period should be provided, wherein the at least one barrier layer may perfectly well be constructed from various ones of the above-indicated materials or the compounds thereof and may in this case also exhibit a layered construction of different materials or compounds.

Barrier layers which comprise the material B₄C and have a thickness of between 0.35 nm and 0.8 nm, preferably between 0.4 nm and 0.6 nm, lead in practice to high reflectivity values of the layer arrangement. Particularly in the case of layer subsystems composed of ruthenium and silicon, barrier layers composed of B₄C exhibit a maximum of reflectivity in the case of values of between 0.4 nm and 0.6 nm for the thickness of the barrier layer.

In the case of the mirrors 1a, 1b, 1c according to the invention, the number N₁, N₂ and N₃ of periods P₁, P₂ and P₃ of the layer subsystems P′, P″ and P′″ can comprise in each case up to 100 periods of the individual periods P₁, P₂ and P₃ illustrated in FIGS. 1 to 3. Furthermore, between the layer arrangements illustrated in FIGS. 1 to 3 and substrate S, an intermediate layer or an intermediate layer arrangement can be provided, which serves for the stress compensation of the layer arrangement with respect to the substrate.

The same materials in the same sequence as for the layer arrangement itself can be used as materials for the intermediate layer or the intermediate layer arrangement. In the case of the intermediate layer arrangement, however, it is possible to dispense with the barrier layer between the individual layers since the intermediate layer or the intermediate layer arrangement generally makes a negligible contribution to the reflectivity of the mirror and so the issue of an increase in contrast by the barrier layer is unimportant in this case. Multilayer arrangements composed of alternating chromium and scandium layers or amorphous molybdenum or ruthenium layers would likewise be conceivable as the intermediate layer or intermediate layer arrangement. The latter can be chosen in terms of their thickness, e.g. greater than 20 nm, such that an underlying substrate is sufficiently protected from EUV radiation. In this case, the layers would act as a so-called “Surface Protective Layer” (SPL) and afford protection from EUV radiation as a protective layer.

The layer arrangements of the mirrors 1a, 1b, 1c according to the invention are terminated in FIGS. 1 to 3 by a covering layer system C comprising at least one layer composed of a chemically inert material such as e.g. Rh, Pt, Ru, Pd, Au, SiO2 etc. as a terminating layer M. Said terminating layer M thus prevents the chemical alteration of the mirror surface on account of ambient influences. The covering layer system C in FIGS. 1 to 3 consists, besides the terminating layer M, of a high refractive index layer H, a low refractive index layer L and a barrier layer B.

The thickness of one of the periods P₁, P₂ and P₃ results from FIGS. 1 to 3 as the sum of the thicknesses of the individual layers of the corresponding period, that is to say from the thickness of the high refractive index layer, the thickness of the low refractive index layer and the thickness of two barrier layers. Consequently, the layer subsystems P′, P″ and P′″ in FIGS. 1 to 3 can be distinguished from one another by virtue of the fact that their periods P₁, P₂ and P₃ have a different thickness d₁, d₂ and d₃. Consequently, in the context of the present invention, different layer subsystems P′, P″ and P′″ are understood to be layer subsystems whose periods P₁, P₂ and P₃ differ by more than 0.1 nm in their thicknesses d₁, d₂ and d₃, since a different optical effect of the layer subsystems can no longer be assumed below a difference of 0.1 nm given otherwise identical division of the periods between high and low refractive index layers. Furthermore, inherently identical layer subsystems can fluctuate by this absolute value in their period thicknesses during their production on different production apparatuses. For the case of a layer subsystem P′, P″ and P′″ having a period composed of molybdenum and silicon, it is also possible, as already described above, to dispense with the second barrier layer within the period P₁, P₂ and P₃, such that in this case the thickness of the periods P₁, P₂ and P₃ results from the thickness of the high refractive index layer, the thickness of the low refractive index layer and the thickness of a barrier layer.

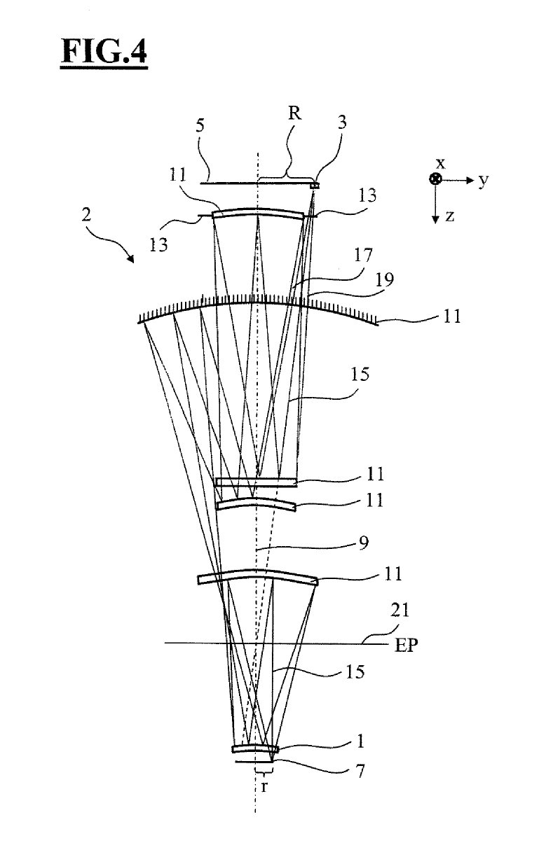

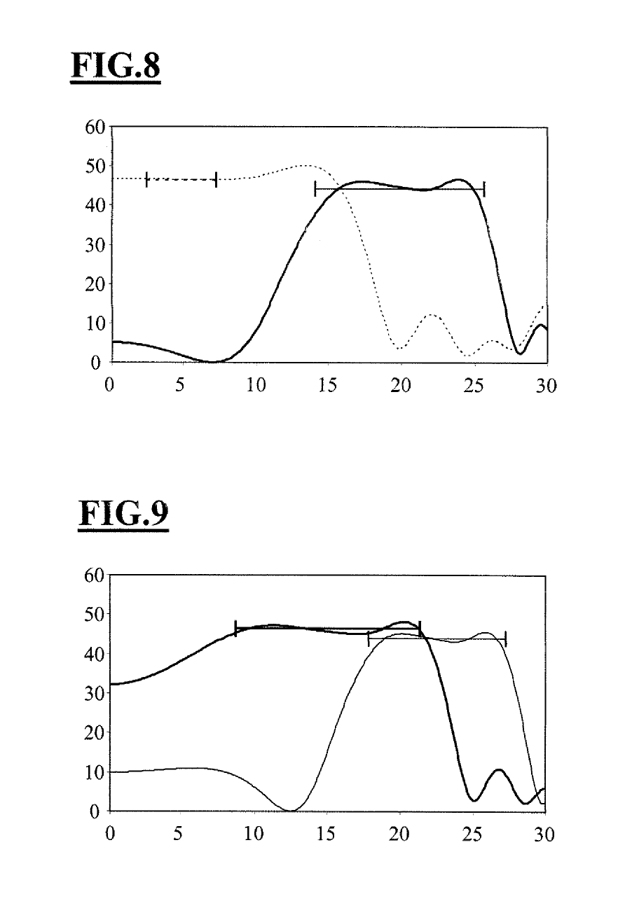

FIG. 4 shows a schematic illustration of a projection objective 2 according to the invention for a projection exposure apparatus for microlithography having six mirrors 1, 11, including at least one mirror 1 configured on the basis of the mirrors la, 1b or 1c according to the invention in accordance with the exemplary embodiments with respect to FIGS. 8 to 15. The task of a projection exposure apparatus for microlithography is to image the structures of a mask, which is also referred to as a reticle, lithographically onto a so-called wafer in an image plane. For this purpose, a projection objective 2 according to the invention in FIG. 4 images an object field 3, which is arranged in the object plane 5, into an image field in the image plane 7. The structure-bearing mask, which is not illustrated in the drawing for the sake of clarity, can be arranged at the location of the object field 3 in the object plane 5. For orientation purposes, FIG. 4 illustrates a system of Cartesian coordinates, the x-axis of which points into the plane of the figure. In this case, the x-y coordinate plane coincides with the object plane 5, the z-axis being perpendicular to the object plane 5 and pointing downward. The projection objective has an optical axis 9, which does not run through the object field 3. The mirrors 1, 11 of the projection objective 2 have a design surface that is rotationally symmetrical with respect to the optical axis. In this case, said design surface must not be confused with the physical surface of a finished mirror, since the latter surface is trimmed relative to the design surface in order to ensure passages of light past the mirror. In this exemplary embodiment, the aperture stop 13 is arranged on the second mirror 11 in the light path from the object plane 5 to the image plane 7. The effect of the projection objective 2 is illustrated with the aid of three rays, the principal ray 15 and the two aperture marginal rays 17 and 19, all of which originate in the center of the object field 3.

The principal ray 15, which runs at an angle of 6° with respect to the perpendicular to the object plane, intersects the optical axis 9 in the plane of the aperture stop 13. As viewed from the object plane 5, the principal ray 15 appears to intersect the optical axis in the entrance pupil plane 21. This is indicated in FIG. 4 by the dashed extension of the principal ray 15 through the first mirror 11. Consequently, the virtual image of the aperture stop 13, the entrance pupil, lies in the entrance pupil plane 21. The exit pupil of the projection objective could likewise be found with the same construction in the backward extension of the principal ray 15 proceeding from the image plane 7. However, in the image plane 7 the principal ray 15 is parallel to the optical axis 9, and from this it follows that the backward projection of these two rays produces a point of intersection at infinity in front of the projection objective 2 and the exit pupil of the projection objective 2 is thus at infinity. Therefore, this projection objective 2 is a so-called objective that is telecentric on the image side. The center of the object field 3 is at a distance R from the optical axis 9 and the center of the image field 7 is at a distance r from the optical axis 9, in order that no undesirable vignetting of the radiation emerging from the object field occurs in the case of the reflective configuration of the projection objective.

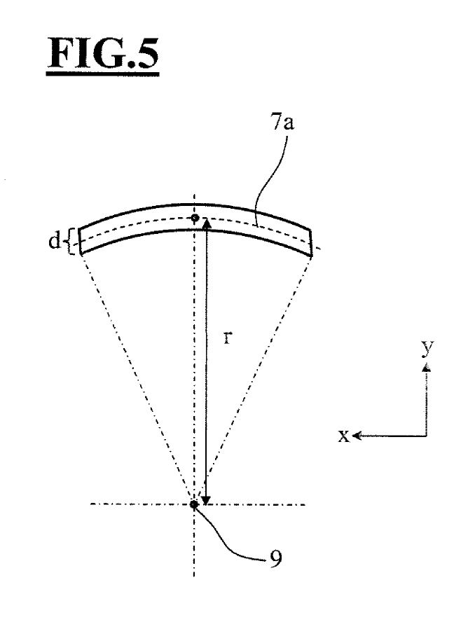

FIG. 5 shows a plan view of an arcuate image field 7a such as occurs in the projection objective 2 illustrated in FIG. 4, and a system of Cartesian coordinates, the axes of which correspond to those from FIG. 4. The image field 7a is a sector from an annulus, the center of which is given by the point of intersection of the optical axis 9 with the object plane. The average radius r is 34 mm in the case illustrated. The width of the field in the y-direction d is 2 mm here. The central field point of the image field 7a is marked as a small circle within the image field 7a. As an alternative, a curved image field can also be delimited by two circle arcs which have the same radius and are displaced relative to one another in the y-direction. If the projection exposure apparatus is operated as a scanner, then the scanning direction runs in the direction of the shorter extent of the object field, that is to say in the direction of the y-direction.

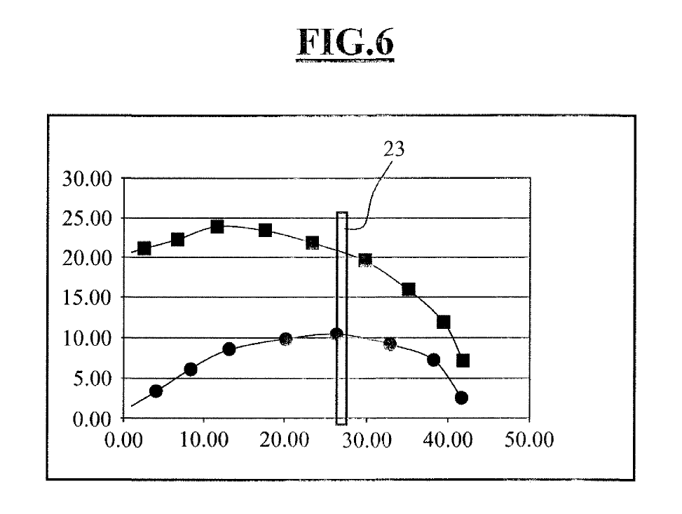

FIG. 6 shows an exemplary illustration of the maximum angles of incidence (rectangles) and of the interval lengths of the angle of incidence intervals (circles) in the unit degrees [°] against different radii or distances between the locations of the mirror surface and the optical axis, indicated in the unit [mm], of the penultimate mirror 1 in the light path from the object plane 5 to the image plane 7 of the projection objective 2 from FIG. 4. Said mirror 1, in the case of a projection objective 2 for microlithography which has six mirrors 1, 11 for the EUV wavelength range, is generally that mirror which has to ensure the largest angles of incidence and the largest angle of incidence intervals or the greatest variation of angles of incidence. In the context of this application, the interval length of an angle of incidence interval as a measure of the variation of angles of incidence is understood to be the number of angular degrees of that angular range in degrees between the maximum and minimum angles of incidence which the coating of the mirror has to ensure for a given distance from the optical axis on account of the requirements of the optical design. The angle of incidence interval will also be abbreviated to AOI interval.

The optical data of the projection objective in accordance with table 1 are applicable in the case of the mirror 1 on which FIG. 6 is based. In this case, the aspheres of the mirrors 1, 11 of the optical design are specified as rotationally symmetrical surfaces using the perpendicular distance Z(h) of an asphere point relative to the tangential plane in the asphere vertex as a function of the perpendicular distance h of the asphere point with respect to the normal in the asphere vertex in accordance with the following asphere equation:

Z(h)=(rho*h²)/(1+[1−(1+k_{y})*(rho*h)²]^{0.5})++c₁*h4+c₂*h⁶+c₃*h⁸+c₄*h¹⁰+c₅*h¹²+c₆*h¹⁴

with the radius R=1/rho of the mirror and the parameters k_{y}, c₁, c₂, c₃, c₄, c₅, and c₆ in the unit [mm]. In this case the said parameters cₙ are normalized with regard to the unit [mm] in accordance with [1/mm²ⁿ⁺²] in such a way as to result in the asphere Z(h) as a function of the distance h also in the unit [mm].

TABLE 1
Data of the optical design regarding the angles of incidence of the mirror 1 in FIG. 6
in accordance with the schematic illustration of the design on the basis of FIG. 4.

| Designation of | | | |
|---|---|---|---|
| the surface in | | Distance from the | |
| accordance with | | nearest surface in | Asphere parameters with the unit |
| FIG. 2 | Radius R in [mm] | [mm] | [1/mm²ⁿ⁺²] for cₙ |
| Object plane 5 | Infinity | 697.657821079643 | |
| 1st mirror 11 | −3060.189398512395 | 494.429629463009 | k_{y} = 0.00000000000000E+00 |
| | | | c₁ = 8.46747658600840E−10 |
| | | | c₂ = −6.38829035308911E−15 |
| | | | c₃ = 2.99297298249148E−20 |
| | | | c₄ = 4.89923345704506E−25 |
| | | | c₅ = −2.62811636654902E−29 |
| | | | c₆ = 4.29534493103729E−34 |
| 2nd mirror 11 | −1237.831140064837 | 716.403660000000 | k_{y} = 3.05349335818189E+00 |
| -- diaphragm -- | | | c₁ = 3.01069673080653E−10 |
| | | | c₂ = 3.09241275151742E−16 |
| | | | c₃ = 2.71009214786939E−20 |
| | | | c₄ = −5.04344434347305E−24 |
| | | | c₅ = 4.22176379615477E−28 |
| | | | c₆ = −1.41314914233702E−32 |
| 3rd mirror 11 | 318.277985359899 | 218.770165786534 | k_{y} = −7.80082610035452E−01 |
| | | | c₁ = 3.12944645776932E−10 |
| | | | c₂ = −1.32434614339199E−14 |
| | | | c₃ = 9.56932396033676E−19 |
| | | | c₄ = −3.13223523243916E−23 |
| | | | c₅ = 4.73030659773901E−28 |
| | | | c₆ = −2.70237216494288E−33 |
| 4th mirror 11 | −513.327287349838 | 892.674538915941 | k_{y} = −1.05007411819774E−01 |
| | | | c₁ = −1.33355977877878E−12 |
| | | | c₂ = −1.71866358951357E−16 |
| | | | c₃ = 6.69985430179187E−22 |
| | | | c₄ = 5.40777151247246E−27 |
| | | | c₅ = −1.16662974927332E−31 |
| | | | c₆ = 4.19572235940121E−37 |
| Mirror 1 | 378.800274177878 | 285.840721874570 | k_{y} = 0.00000000000000E+00 |
| | | | c₁ = 9.27754883183223E−09 |
| | | | c₂ = 5.96362556484499E−13 |
| | | | c₃ = 1.56339572303953E−17 |
| | | | c₄ = −1.41168321383233E−21 |
| | | | c₅ = 5.98677250336455E−25 |
| | | | c₆ = −6.30124060830317E−29 |
| 5th mirror 11 | −367.938526548613 | 325.746354374172 | k_{y} = 1.07407597789597E−01 |
| | | | c₁ = 3.87917960004046E−11 |
| | | | c₂ = −3.43420257078373E−17 |
| | | | c₃ = 2.26996395088275E−21 |
| | | | c₄ = −2.71360350994977E−25 |
| | | | c₅ = 9.23791176750829E−30 |
| | | | c₆ = −1.37746833100643E−34 |
| Image plane 7 | infinity | | |

It can be discerned from FIG. 6 that maximum angles of incidence of 24° and interval lengths of 11° occur at different locations of the mirror 1. Consequently, the layer arrangement of the mirror 1 has to yield high and uniform reflectivity values at these different locations for different angles of incidence and different angle of incidence intervals, since otherwise a high total transmission and an acceptable pupil apodization of the projection objective 2 cannot be ensured.

The so-called PV value is used as a measure of the variation of the reflectivity of a mirror over the angles of incidence. In this case, the PV value is defined as the difference between the maximum reflectivity Rₘₐₓ and the minimum reflectivity Rₘᵢₙ in the angle of incidence interval under consideration divided by the average reflectivity R_{average} in the angle of incidence interval under consideration. Consequently, PV=(Rₘₐₓ−Rₘᵢₙ)/R_{average} holds true

In this case, it should be taken into consideration that high PV values for a mirror 1 of the projection objective 2 as penultimate mirror before the image plane 7 in accordance with FIG. 4 and the design in table 1 lead to high values for the pupil apodization. In this case, there is a correlation between the PV value of the mirror 1 and the imaging aberration of the pupil apodization of the projection objective 2 for high PV values of greater than 0.25 since, starting from this value, the PV value dominates the pupil apodization relative to other causes of aberration.

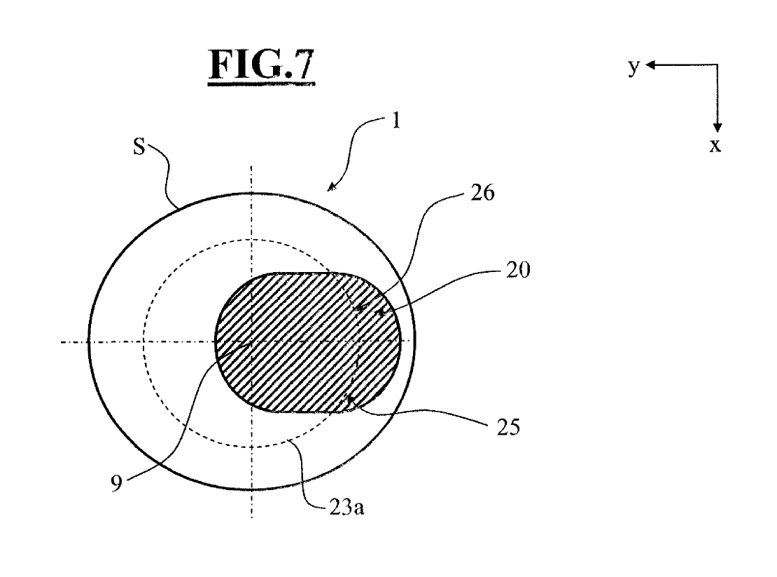

In FIG. 6, a bar 23 is used to mark by way of example a specific radius or a specific distance of the locations of the mirror 1 having the associated maximum angle of incidence of approximately 21° and the associated interval length of 11° with respect to the optical axis. Said marked radius corresponds in FIG. 7, described below, to the locations on the circle 23a—illustrated in dashed fashion—within the hatched region 20, which represents the optically utilized region 20 of the mirror 1.

FIG. 7 shows the substrate S of the penultimate mirror 1 in the light path from the object plane 5 to the image plane 7 of the projection objective 2 from FIG. 4 as a circle centered with respect to the optical axis 9 in plan view. In this case, the optical axis 9 of the projection objective 2 corresponds to the axis 9 of symmetry of the substrate. Furthermore, in FIG. 7, the optically utilized region 20 of the mirror 1, said region being offset with respect to the optical axis, is depicted in hatched fashion and a circle 23a is depicted in dashed fashion.

In this case, the part of the dashed circle 23a within the optically utilized region corresponds to the locations of the mirror 1 which are identified by the depicted bar 23 in FIG. 6. Consequently, the layer arrangement of the mirror 1 along the partial region of the dashed circle 23a within the optically utilized region 20, in accordance with the data from FIG. 6, has to ensure high reflectivity values both for a maximum angle of incidence of 21° and for a minimum angle of incidence of approximately 10°. In this case, the minimum angle of incidence of approximately 10° results from the maximum angle of incidence of 21° from FIG. 6 on account of the interval length of 11°. The locations on the dashed circle at which the two abovementioned extreme values of the angles of incidence occur are emphasized in FIG. 7 by the tip of the arrow 26 for the angle of incidence of 10° and by the tip of the arrow 25 for the angle of incidence of 21°.

Since a layer arrangement cannot be varied locally over the locations of a substrate S without high technological outlay and layer arrangements are generally applied rotationally symmetrically with respect to the axis 9 of symmetry of the substrate, the layer arrangement along the locations of the dashed circle 23a in FIG. 7 comprises one and the same layer arrangement such as is shown in its basic construction in FIGS. 1 to 3 and is explained in the form of specific exemplary embodiments with reference to FIGS. 8 to 15. In this case, it should be taken into consideration that a rotationally symmetrical coating of the substrate S with respect to the axis 9 of symmetry of the substrate S with the layer arrangement has the effect that the periodic sequence of the layer subsystems P′, P″ and P′″ of the layer arrangement is maintained at all locations of the mirror and only the thickness of the periods of the layer arrangement depending on the distance from the axis 9 of symmetry acquires a rotationally symmetrical profile over the substrate S, the layer arrangement being thinner at the edge of the substrate S than in the center of the substrate S at the axis 9 of symmetry.

It should be taken into consideration that it is possible, with suitable coating technology, for example by the use of distribution diaphragms, to adapt the rotationally symmetrical radial profile of the thickness of a coating over the substrate. Consequently, in addition to the design of the coating per se, with the radial profile of the so-called thickness factor of the coating design over the substrate, a further degree of freedom is available for optimizing the coating design.

The reflectivity values illustrated in FIGS. 8 to 15 were calculated using the complex refractive indices ñ=n−i*k indicated in table 2 for the utilized materials at the wavelength of 13.5 nm. In this case, it should be taken into consideration that reflectivity values of real mirrors can turn out to be lower than the theoretical reflectivity values illustrated in FIGS. 8 to 15, since in particular the refractive indices of real thin layers can deviate from the literature values mentioned in table 2.

TABLE 2
Employed refractive indices ñ = n − i * k for 13.5 nm

| | Chemical | Layer design | | |
|---|---|---|---|---|
| Material | symbol | symbol | n | k |
| Substrate | | | 0.973713 | 0.0129764 |
| Silicon | Si | H, H′, H″, H′″ | 0.999362 | 0.00171609 |
| Boron carbide | B₄C | B | 0.963773 | 0.0051462 |
| Molybdenum | Mo | L, L′, L″, L′″ | 0.921252 | 0.0064143 |
| Ruthenium | Ru | M, L, L′, L″, L′″ | 0.889034 | 0.0171107 |
| Vacuum | | | 1 | 0 |

Moreover, the following short notation in accordance with the layer sequence with respect to FIGS. 1 to 3 is declared for the layer designs associated with FIGS. 8 to 15:

Substrate/ . . . /(P₁)*N₁/(P₂)*N₂/(P₃)*N₃/covering layer system C
where

### P1=H′BL′B; P2=H″BL″B; P3=H′″BL′″B; C=HBLM;

for FIGS. 2 and 3 and where

### P1=BH′BL′; P2=BL″BH″; P3=H′″BL′″B; C=HBLM;

for FIG. 1 and for the fourth exemplary embodiment as a variant with respect to FIG. 3.

In this case, the letters H symbolically represent the thickness of high refractive index layers, the letters L represent the thickness of low refractive index layers, the letter B represents the thickness of the barrier layer and the letter M represents the thickness of the chemically inert terminating layer in accordance with table 2 and the description concerning FIGS. 1 to 3.

In this case, the unit [nm] applies to the thicknesses of the individual layers that are specified between the parentheses. The layer design used with respect to FIGS. 8 and 9 can thus be specified as follows in the short notation:

Substrate/ . . . /(0.4B₄C 2.921Si 0.4B₄C 4.931Mo)*8/(0.4B₄C 4.145Mo 0.4B₄C 2.911Si)*5/(3.509Si 0.4B₄C 3.216Mo 0.4B₄C)*16/2.975Si 0.4B₄C 2Mo 1.5Ru

Since the barrier layer B₄C in this example is always 0.4 nm thick, it can also be omitted for illustrating the basic construction of the layer arrangement, such that the layer design with respect to FIGS. 8 and 9 can be specified in a manner shortened as follows:

### Substrate/ . . . /(2.921Si 4.931Mo)*8/(4.145Mo 2.911Si)*5/(3.509Si 3.216Mo)*16/2.975Si 2Mo 1.5Ru

It should be recognized from this first exemplary embodiment according to FIG. 1 that the order of the high refractive index layer Si and the low refractive index layer Mo in the second layer subsystem, comprising five periods, has been reversed relative to the other layer subsystems, such that the first high refractive index layer of the layer subsystem that is most distant from the substrate, with a thickness of 3.509 nm, directly succeeds the last high refractive index layer of the layer subsystem that is second most distant from the substrate, with a thickness of 2.911 nm.

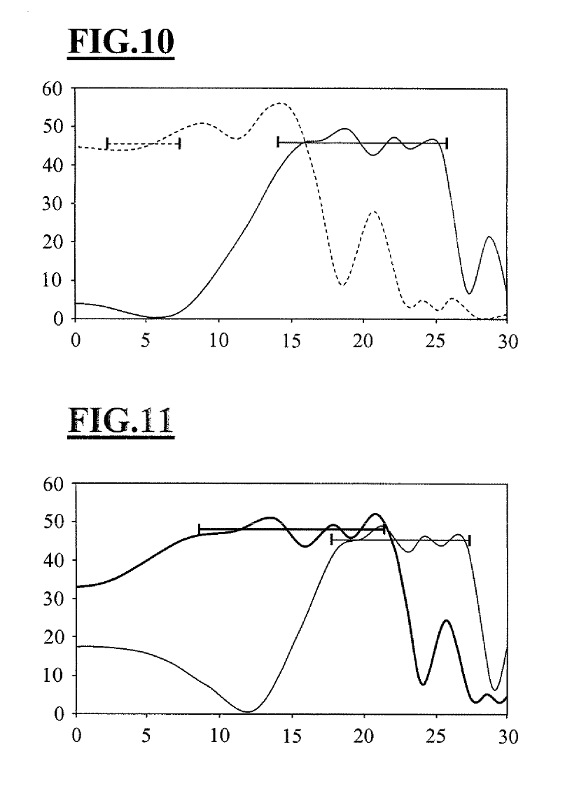

Correspondingly, it is possible to specify the layer design used with respect to FIGS. 10 and 11 as second exemplary embodiment in accordance with FIG. 2 in the short notation as:

Substrate/ . . . /(4.737Si 0.4B₄C 2.342Mo 0.4B₄C)*28/(3.443Si 0.4B₄C 2.153Mo 0.4B₄C)*5/(3.523Si 0.4B₄C 3.193Mo 0.4B₄C)*15/2.918Si 0.4B₄C 2Mo 1.5Ru

Since the barrier layer B₄C in this example is in turn always 0.4 nm thick, it can also be omitted for illustrating this layer arrangement, such that the layer design with respect to FIGS. 10 and 11 can be specified in a manner shortened as follows:

### Substrate/ . . . /(4.737Si 2.342Mo)*28/(3.443Si 2.153Mo)*5/(3.523Si 3.193Mo)*15/2.918Si 2Mo 1.5Ru

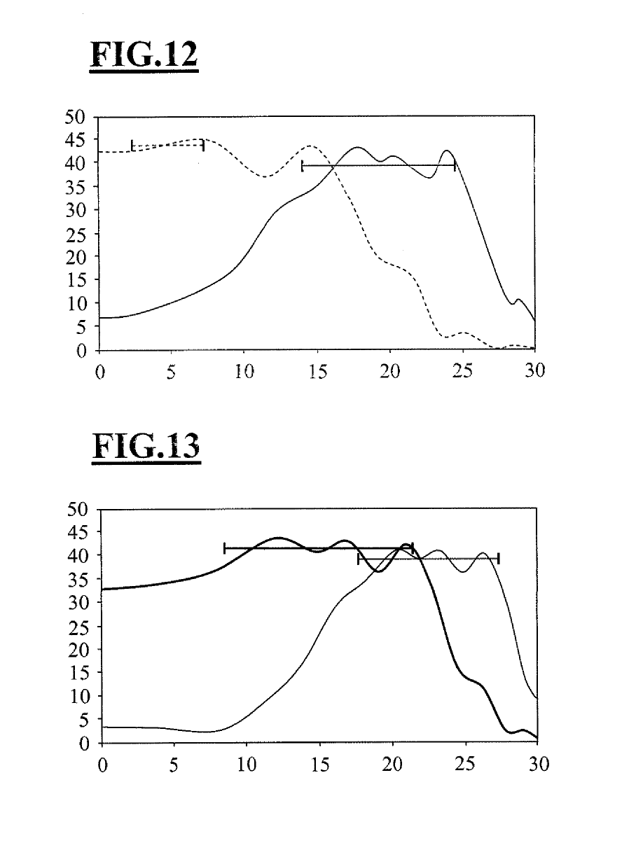

Accordingly, it is possible to specify the layer design used with respect to FIGS. 12 and 13 as third exemplary embodiment in accordance with FIG. 3 in the short notation as:

### Substrate/ . . . /(1.678Si 0.4B₄C 5.665Mo 0.4B₄C)*27/(3.798Si 0.4B₄C 2.855Mo 0.4B₄C)*14/1.499Si 0.4B₄C 2Mo 1.5Ru

and, disregarding the barrier layer B₄C for illustration purposes, as:

### Substrate/ . . . /(1.678Si 5.665Mo)*27/(3.798Si 2.855Mo)*14/1.499Si 2Mo 1.5Ru

Likewise, it is possible to specify the layer design used with respect to FIGS. 14 and 15 as fourth exemplary embodiment in accordance with a variant with respect to FIG. 3 in the short notation as:

### Substrate/ . . . /(0.4B₄C 4.132Mo 0.4B₄C 2.78Si)*6/(3.608Si 0.4B₄C 3.142Mo 0.4B₄C)*16/2.027Si 0.4B₄C 2Mo 1.5Ru

and, disregarding the barrier layer B₄C for illustration purposes, as:

### Substrate/ . . . /(4.132Mo 2.78Si)*6/(3.609Si 3.142Mo)*16/2.027Si 2Mo 1.5Ru

It should be recognized from this fourth exemplary embodiment that the order of the high refractive index layer Si and the low refractive index layer Mo in the layer subsystem P″, comprising six periods, has been reversed relative to the other layer subsystem P′″ having 16 periods, such that the first high refractive index layer of the layer subsystem P′″ that is most distant from the substrate, with a thickness of 3.609 nm, directly succeeds the last high refractive index layer of the layer subsystem P″ that is second most distant from the substrate, with a thickness of 2.78 nm.

This fourth exemplary embodiment is therefore a variant of the third exemplary embodiment in which the order of the high and low refractive index layers in the layer subsystem P″ that is second most distant from the substrate has been reversed according to the first exemplary embodiment with respect to FIG. 1.

FIG. 8 shows reflectivity values for unpolarized radiation in the unit [%] of the first exemplary embodiment of a mirror 1a according to the invention in accordance with FIG. 1 plotted against the angle of incidence in the unit [°]. In this case, the first layer subsystem P′ of the layer arrangement of the mirror 1a consists of N₁=8 periods P₁, wherein the period P₁ consists of 2.921 nm Si as high refractive index layer and 4.931 nm Mo as low refractive index layer, and also of two barrier layers each comprising 0.4 nm B₄C. The period P₁ consequently has a thickness d₁ of 8.652 nm. The second layer subsystem P″ of the layer arrangement of the mirror 1a having the reversed order of the layers Mo and Si consists of N₂=5 periods P₂, wherein the period P₂ consists of 2.911 nm Si as high refractive index layer and 4.145 nm Mo as low refractive index layer, and also of two barrier layers each comprising 0.4 nm B₄C. The period P₂ consequently has a thickness d₂ of 7.856 nm. The third layer subsystem P′″ of the layer arrangement of the mirror 1a consists of N₃=16 periods P₃, wherein the period P₃ consists of 3.509 nm Si as high refractive index layer and 3.216 nm Mo as low refractive index layer, and also of two barrier layers each comprising 0.4 nm B₄C. The period P₃ consequently has a thickness d₃ of 7.525 nm. The layer arrangement of the mirror 1a is terminated by a covering layer system C consisting of 2.975 nm Si, 0.4 nm B₄C, 2 nm Mo and 1.5 nm Ru in the order specified. Consequently, the layer subsystem P′″ that is most distant from the substrate has a number N₃ of periods P₃ that is greater than the number N₂ of periods P₂ for the layer subsystem P″ that is second most distant from the substrate and the first high refractive index layer H′″ of the layer subsystem P′″ that is most distant from the substrate directly succeeds the last high refractive index layer H″ of the layer subsystem P″ that is second most distant from the substrate.

The reflectivity values of this nominal layer design with the thickness factor 1 in the unit [%] at a wavelength of 13.5 nm are illustrated as a solid line against the angle of incidence in the unit [°] in FIG. 8. Moreover, the average reflectivity of this nominal layer design for the angle of incidence interval of 14.1° to 25.7° is depicted as a solid horizontal bar. Furthermore, FIG. 8 correspondingly specifies, at a wavelength of 13.5 nm and given a thickness factor of 0.933, as a dashed line the reflectivity values against the angles of incidence and as a dashed bar the average reflectivity of the above-specified layer design for the angle of incidence interval of 2.5° to 7.3°. Consequently, the thicknesses of the periods of the layer arrangement with respect to the reflectivity values illustrated as a dashed line in FIG. 8 amount to only 93.3% of the corresponding thicknesses of the periods of the nominal layer design. In other words, the layer arrangement is thinner than the nominal layer design by 6.7% at the mirror surface of the mirror 1a at the locations at which angles of incidence of between 2.5° and 7.3° have to be ensured.

FIG. 9 shows, at a wavelength of 13.5 nm and given a thickness factor of 1.018, in a manner corresponding to FIG. 8, as a thin line the reflectivity values against the angles of incidence and as a thin bar the average reflectivity of the above-specified layer design for the angle of incidence interval of 17.8° to 27.2°, and also, given a thickness factor of 0.972, in a corresponding manner, as a thick line the reflectivity values against the angles of incidence and as a thick bar the average reflectivity of the above-specified layer design for the angle of incidence interval of 8.7° to 21.4°. Consequently, the layer arrangement is thicker than the nominal layer design by 1.8% at the mirror surface of the mirror 1a at the locations at which angles of incidence of between 17.8° and 27.2° have to be ensured and is correspondingly thinner than the nominal layer design by 2.8% at the locations at which angles of incidence of between 8.7° and 21.4° have to be ensured.

The average reflectivity and PV values which can be achieved by the layer arrangement with respect to FIG. 8 and FIG. 9 are compiled relative to the angle of incidence intervals and the thickness factors in table 3. It can be discerned that the mirror 1a comprising the layer arrangement specified above, at a wavelength of 13.5 nm for angles of incidence of between 2.5° and 27.2°, has an average reflectivity of more than 43% and a variation of the reflectivity as PV value of less than or equal to 0.21.

TABLE 3
Average reflectivity and PV values of the layer design with respect
to FIG. 8 and FIG. 9 relative to the angle of incidence interval
in degrees and the thickness factor chosen.

| AOI Interval | Thickness | R_average | |
|---|---|---|---|
| [°] | factor | [%] | PV |
| 17.8-27.2 | 1.018 | 43.9 | 0.14 |
| 14.1-25.7 | 1 | 44.3 | 0.21 |
| 8.7-21.4 | 0.972 | 46.4 | 0.07 |
| 2.5-7.3 | 0.933 | 46.5 | 0.01 |

FIG. 10 shows reflectivity values for unpolarized radiation in the unit [%] of the second exemplary embodiment of a mirror 1b according to the invention in accordance with FIG. 2 plotted against the angle of incidence in the unit [°]. In this case, the first layer subsystem P′ of the layer arrangement of the mirror 1b consists of N₁=28 periods P₁, wherein the period P₁ consists of 4.737 nm Si as high refractive index layer and 2.342 nm Mo as low refractive index layer, and also of two barrier layers each comprising 0.4 nm B₄C. The period P₁ consequently has a thickness d₁ of 7.879 nm. The second layer subsystem P″ of the layer arrangement of the mirror 1b consists of N₂=5 periods P₂, wherein the period P₂ consists of 3.443 nm Si as high refractive index layer and 2.153 nm Mo as low refractive index layer, and also of two barrier layers each comprising 0.4 nm B₄C. The period P₂ consequently has a thickness d₂ of 6.396 nm. The third layer subsystem P′ of the layer arrangement of the mirror 1b consists of N₃=15 periods P₃, wherein the period P₃ consists of 3.523 nm Si as high refractive index layer and 3.193 nm Mo as low refractive index layer, and also of two barrier layers each comprising 0.4 nm B₄C. The period P₃ consequently has a thickness d₃ of 7.516 nm. The layer arrangement of the mirror 1b is terminated by a covering layer system C consisting of 2.918 nm Si, 0.4 nm B₄C, 2 nm Mo and 1.5 nm Ru in the order specified. Consequently, the layer subsystem P′ that is most distant from the substrate has a number N₃ of periods P₃ that is greater than the number N₂ of periods P₂ for the layer subsystem P″ that is second most distant from the substrate.

The reflectivity values of this nominal layer design with the thickness factor 1 in the unit [%] at a wavelength of 13.5 nm are illustrated as a solid line against the angle of incidence in the unit [°] in FIG. 10. Moreover, the average reflectivity of this nominal layer design for the angle of incidence interval of 14.1° to 25.7° is depicted as a solid horizontal bar. Furthermore, FIG. 10 correspondingly specifies, at a wavelength of 13.5 nm and given a thickness factor of 0.933, as a dashed line the reflectivity values against the angles of incidence and as a dashed bar the average reflectivity of the above-specified layer design for the angle of incidence interval of 2.5° to 7.3°. Consequently, the thicknesses of the periods of the layer arrangement with respect to the reflectivity values illustrated as a dashed line in FIG. 10 amount to only 93.3% of the corresponding thicknesses of the periods of the nominal layer design. In other words, the layer arrangement is thinner than the nominal layer design by 6.7% at the mirror surface of the mirror 1b at the locations at which angles of incidence of between 2.5° and 7.3° have to be ensured.

FIG. 11 shows, at a wavelength of 13.5 nm and given a thickness factor of 1.018, in a manner corresponding to FIG. 10, as a thin line the reflectivity values against the angles of incidence and as a thin bar the average reflectivity of the above-specified layer design for the angle of incidence interval of 17.8° to 27.2°, and also, given a thickness factor of 0.972, in a corresponding manner, as a thick line the reflectivity values against the angles of incidence and as a thick bar the average reflectivity of the above-specified layer design for the angle of incidence interval of 8.7° to 21.4°. Consequently, the layer arrangement is thicker than the nominal layer design by 1.8% at the mirror surface of the mirror 1b at the locations at which angles of incidence of between 17.8° and 27.2° have to be ensured and is correspondingly thinner than the nominal layer design by 2.8% at the locations at which angles of incidence of between 8.7° and 21.4° have to be ensured.

The average reflectivity and PV values which can be achieved by the layer arrangement with respect to FIG. 10 and FIG. 11 are compiled relative to the angle of incidence intervals and the thickness factors in table 4. It can be discerned that the mirror 1b comprising the layer arrangement specified above, at a wavelength of 13.5 nm for angles of incidence of between 2.5° and 27.2°, has an average reflectivity of more than 45% and a variation of the reflectivity as PV value of less than or equal to 0.23.

TABLE 4
Average reflectivity and PV values of the layer design with respect
to FIG. 10 and FIG. 11 relative to the angle of incidence interval in
degrees and the thickness factor chosen.

| AOI Interval | Thickness | R_average | |
|---|---|---|---|
| [°] | factor | [%] | PV |
| 17.8-27.2 | 1.018 | 45.2 | 0.17 |
| 14.1-25.7 | 1 | 45.7 | 0.23 |
| 8.7-21.4 | 0.972 | 47.8 | 0.18 |
| 2.5-7.3 | 0.933 | 45.5 | 0.11 |

FIG. 12 shows reflectivity values for unpolarized radiation in the unit [%] of the third exemplary embodiment of a mirror 1c according to the invention in accordance with FIG. 3 plotted against the angle of incidence in the unit [°]. In this case, the layer subsystem P″ of the layer arrangement of the mirror 1c consists of N₂=27 periods P₂, wherein the period P₂ consists of 1.678 nm Si as high refractive index layer and 5.665 nm Mo as low refractive index layer, and also of two barrier layers each comprising 0.4 nm B₄C. The period P₂ consequently has a thickness d₂ of 8.143 nm. The layer subsystem P′″ of the layer arrangement of the mirror 1c consists of N₃=14 periods P₃, wherein the period P₃ consists of 3.798 nm Si as high refractive index layer and 2.855 nm Mo as low refractive index layer, and also of two barrier layers each comprising 0.4 nm B₄C. Consequently, the period P₃ has a thickness d₃ of 7.453 nm. The layer arrangement of the mirror 1c is terminated by a covering layer system C consisting of 1.499 nm Si, 0.4 nm B₄C, 2 nm Mo and 1.5 nm Ru in the order specified. Consequently, the layer subsystem P′″ that is most distant from the substrate has a thickness of the high refractive index layer H′″ that amounts to more than double the thickness of the high refractive index layer H″ of the layer subsystem P″ that is second most distant from the substrate.

The reflectivity values of this nominal layer design with the thickness factor 1 in the unit [%] at a wavelength of 13.5 nm are illustrated as a solid line against the angle of incidence in the unit [°] in FIG. 12. Moreover, the average reflectivity of this nominal layer design for the angle of incidence interval of 14.1° to 25.7° is depicted as a solid horizontal bar. Furthermore, FIG. 12 correspondingly specifies, at a wavelength of 13.5 nm and given a thickness factor of 0.933, as a dashed line the reflectivity values against the angles of incidence and as a dashed bar the average reflectivity of the above-specified layer design for the angle of incidence interval of 2.5° to 7.3°. Consequently, the thicknesses of the periods of the layer arrangement with respect to the reflectivity values illustrated as a dashed line in FIG. 12 amount to only 93.3% of the corresponding thicknesses of the periods of the nominal layer design. In other words, the layer arrangement is thinner than the nominal layer design by 6.7% at the mirror surface of the mirror 1c at the locations at which angles of incidence of between 2.5° and 7.3° have to be ensured.

FIG. 13 shows in a manner corresponding to FIG. 12, at a wavelength of 13.5 nm and given a thickness factor of 1.018, as a thin line the reflectivity values against the angles of incidence and as a thin bar the average reflectivity of the above-specified layer design for the angle of incidence interval of 17.8° to 27.2°, and also, given a thickness factor of 0.972, in a corresponding manner, as a thick line the reflectivity values against the angles of incidence and as a thick bar the average reflectivity of the above-specified layer design for the angle of incidence interval of 8.7° to 21.4°. Consequently, the layer arrangement is thicker than the nominal layer design by 1.8% at the mirror surface of the mirror 1c at the locations at which angles of incidence of between 17.8° and 27.2° have to be ensured and is correspondingly thinner than the nominal layer design by 2.8% at the locations at which angles of incidence of between 8.7° and 21.4° have to be ensured.

The average reflectivity and PV values which can be achieved by the layer arrangement with respect to FIG. 12 and FIG. 13 are compiled relative to the angle of incidence intervals and the thickness factors in table 5. It can be discerned that the mirror 1c comprising the layer arrangement specified above, at a wavelength of 13.5 nm for angles of incidence of between 2.5° and 27.2°, has an average reflectivity of more than 39% and a variation of the reflectivity as PV value of less than or equal to 0.22.

TABLE 5
Average reflectivity and PV values of the layer design with respect
to FIG. 12 and FIG. 13 relative to the angle of incidence interval in
degrees and the thickness factor chosen.

| AOI Interval | Thickness | R_average | |
|---|---|---|---|
| [°] | factor | [%] | PV |
| 17.8-27.2 | 1.018 | 39.2 | 0.19 |
| 14.1-25.7 | 1 | 39.5 | 0.22 |
| 8.7-21.4 | 0.972 | 41.4 | 0.17 |
| 2.5-7.3 | 0.933 | 43.9 | 0.04 |

FIG. 14 shows reflectivity values for unpolarized radiation in the unit [%] of the fourth exemplary embodiment of a mirror according to the invention as a variant of the mirror 1c in which the order of the layers in the layer subsystem P″ has been reversed, plotted against the angle of incidence in the unit [°]. In this case, the layer subsystem P″ of the layer arrangement of the mirror consists of N₂=6 periods P₂, wherein the period P₂ consists of 2.78 nm Si as high refractive index layer and 4.132 nm Mo as low refractive index layer, and also of two barrier layers each comprising 0.4 nm B₄C. The period P₂ consequently has a thickness d₂ of 7.712 nm. The layer subsystem P′″ of the layer arrangement of the mirror consists of N₃=16 periods P₃, wherein the period P₂ consists of 3.608 nm Si as high refractive index layer and 3.142 nm Mo as low refractive index layer, and also of two barrier layers each comprising 0.4 nm B₄C. The period P₃ consequently has a thickness d₃ of 7.55 nm. The layer arrangement of the mirror is terminated by a covering layer system C consisting of 2.027 nm Si, 0.4 nm B₄C, 2 nm Mo and 1.5 nm Ru in the order specified. Consequently, the layer subsystem P′″ that is most distant from the substrate has a thickness of the high refractive index layer H′″ which amounts to more than 120% of the thickness of the high refractive index layer H″ of the layer subsystem P″ that is second most distant from the substrate. Furthermore, the layer subsystem P′″ that is most distant from the substrate has a number N₃ of periods P₃ that is greater than the number N₂ of periods P₂ for the layer subsystem P″ that is second most distant from the substrate, and the first high refractive index layer H′ of the layer subsystem P′″ that is most distant from the substrate directly succeeds the last high refractive index layer H″ of the layer subsystem P″ that is second most distant from the substrate.

The reflectivity values of this nominal layer design with the thickness factor 1 in the unit [%] at a wavelength of 13.5 nm are illustrated as a solid line against the angle of incidence in the unit [°] in FIG. 14. Moreover, the average reflectivity of this nominal layer design for the angle of incidence interval of 14.1° to 25.7° is depicted as a solid horizontal bar. Furthermore, FIG. 14 correspondingly specifies, at a wavelength of 13.5 nm and given a thickness factor of 0.933, as a dashed line the reflectivity values against the angles of incidence and as a dashed bar the average reflectivity of the above-specified layer design for the angle of incidence interval of 2.5° to 7.3°. Consequently, the thicknesses of the periods of the layer arrangement with respect to the reflectivity values illustrated as a dashed line in FIG. 14 amount to only 93.3% of the corresponding thicknesses of the periods of the nominal layer design. In other words, the layer arrangement is thinner than the nominal layer design by 6.7% at the mirror surface of the mirror according to the invention at the locations at which angles of incidence of between 2.5° and 7.3° have to be ensured.

FIG. 15 shows, at a wavelength of 13.5 nm and given a thickness factor of 1.018, in a manner corresponding to FIG. 14, as a thin line the reflectivity values against the angles of incidence and as a thin bar the average reflectivity of the above-specified layer design for the angle of incidence interval of 17.8° to 27.2°, and also, given a thickness factor of 0.972, in a corresponding manner, as a thick line the reflectivity values against the angles of incidence and as a thick bar the average reflectivity of the above-specified layer design for the angle of incidence interval of 8.7° to 21.4°. Consequently, the layer arrangement is thicker than the nominal layer design by 1.8% at the mirror surface of this mirror according to the invention at the locations at which angles of incidence of between 17.8° and 27.2° have to be ensured and is correspondingly thinner than the nominal layer design by 2.8% at the locations at which angles of incidence of between 8.7° and 21.4° have to be ensured.

The average reflectivity and PV values which can be achieved by the layer arrangement with respect to FIG. 14 and FIG. 15 are compiled relative to the angle of incidence intervals and the thickness factors in table 6. It can be discerned that the mirror according to the invention comprising the layer arrangement specified above, at a wavelength of 13.5 nm for angles of incidence of between 2.5° and 27.2°, has an average reflectivity of more than 42% and a variation of the reflectivity as PV value of less than or equal to 0.24.

TABLE 3
Average reflectivity and PV values of the layer design with respect
to FIG. 14 and FIG. 15 relative to the angle of incidence interval in
degrees and the thickness factor chosen.

| AOI Interval | Thickness | R_average | |
|---|---|---|---|
| [°] | factor | [%] | PV |
| 17.8-27.2 | 1.018 | 42.4 | 0.18 |
| 14.1-25.7 | 1 | 42.8 | 0.24 |
| 8.7-21.4 | 0.972 | 44.9 | 0.15 |
| 2.5-7.3 | 0.933 | 42.3 | 0.04 |

In all four exemplary embodiments shown, the number of periods of the layer subsystem that is respectively situated closest to the substrate can be increased in such a way that the transmission of EUV radiation through the layer subsystems is less than 10%, in particular less than 2%.

Firstly, it is thus possible, as already mentioned in the introduction, to avoid perturbing effects of the layers lying below the layer arrangement or of the substrate on the optical properties of the mirror, and in this case in particular on the reflectivity, and, secondly, it is thereby possible for layers lying below the layer arrangement or the substrate to be sufficiently protected from the EUV radiation.

The above description of the preferred embodiments has been given by way of example. From the disclosure given, those skilled in the art will not only understand the present invention and its attendant advantages, but will also find apparent various changes and modifications to the structures disclosed. The applicant seeks, therefore, to cover all such changes and modifications as fall within the spirit and scope of the invention, as defined by the appended claims, and equivalents thereof.

1. A mirror for radiation in the extreme-ultraviolet (EUV) wavelength range, comprising:
a substrate (S) and a layer arrangement, wherein the layer arrangement comprises a plurality of layer subsystems (P″, P′″) each consisting of a periodic sequence of at least two periods (P₂, P₃) of individual layers, wherein the periods (P₂, P₃) each comprise two individual layers composed of different materials for a high refractive index layer (H″, H′″) and a low refractive index layer (L″, L′″) and have within each layer subsystem (P″, P′″) a constant thickness (d₂, d₃) that deviates from a thickness of the periods of an adjacent layer subsystem, and wherein at least one of:
(i) the layer subsystem (P″) that is second most distant from the substrate (S) has a sequence of the periods (P₂) such that the first high refractive index layer (H′″) of the layer subsystem (P′″) that is most distant from the substrate (S) directly succeeds the last high refractive index layer (H″) of the layer subsystem (P″) that is second most distant from the substrate, and
(ii) the layer subsystem (P′″) that is most distant from the substrate (S) has a number (N₃) of periods (P₃) that is greater than the number (N₂) of periods (P₂) for the layer subsystem (P″) that is second most distant from the substrate (S).

2. A mirror for radiation in the extreme-ultraviolet (EUV) wavelength range, comprising:
a substrate (S) and a layer arrangement, wherein the layer arrangement comprises a plurality of layer subsystems (P″, P′″) each consisting of a periodic sequence of at least two periods (P₂, P₃) of individual layers, wherein the periods (P₂, P₃) each comprise two individual layers composed of different materials for a high refractive index layer (H″, H′″) and a low refractive index layer (L′, L′″) and have within each layer subsystem (P″, P′″) a constant thickness (d₂, d₃) that deviates from a thickness of the periods of an adjacent layer subsystem, wherein the layer subsystem (P″) that is second most distant from the substrate (S) has a sequence of the periods (P₂) such that the first high refractive index layer (H′″) of the layer subsystem (P′″) that is most distant from the substrate (S) directly succeeds the last high refractive index layer (H″) of the layer subsystem (P″) that is second most distant from the substrate (S,) and wherein the transmission of EUV radiation through the layer subsystems (P″, P′″) of the layer arrangement is less than 10%.

3. The mirror according to claim 1, wherein the layer subsystems (P″, P′″) are constructed from the same materials for the high refractive index layer (H″, H′″) and the low refractive index layer (L″, L′″).

4. The mirror according to claim 1, wherein the number (N₃) of periods (P₃) of the layer subsystem (P′″) that is most distant from the substrate (S) is between 9 and 16, and wherein the number (N₂) of periods (P₂) of the layer subsystem (P″) that is second most distant from the substrate (S) is between 2 and 12.

5. The mirror according to claim 1, wherein the layer arrangement comprises at least three layer subsystems (P′, P″, P′″) and the number (N₁) of periods (P₁) of the layer subsystem (P′″) that is situated closest to the substrate (S) is greater than for the layer subsystem (P′″) that is most distant from the substrate (S) and/or is greater than for the layer subsystem (P″) that is second most distant from the substrate (S).

6. The mirror according to claim 1, wherein the period (P₃) for the layer subsystem (P′″) that is most distant from the substrate (S) has a thickness of the high refractive index layer (H′″) which is more than 120% of the thickness of the high refractive index layer (H″) of the period (P₂) for the layer subsystem (P″) that is second most distant from the substrate (S).

7. The mirror according to claim 1, wherein the period (P₃) for the layer subsystem (P′″) that is most distant from the substrate (S) has a thickness of the low refractive index layer (L′″) which is less than 80% of the thickness of the low refractive index layer (L″) of the period (P₂) for the layer subsystem (P″) that is second most distant from the substrate (S).

8. The mirror according to claim 1, wherein the period (P₂) for the layer subsystem (P″) that is second most distant from the substrate (S) has a thickness of the low refractive index layer (L″) that is greater than 4 nm.

9. The mirror according to claim 1, wherein the layer subsystem (P′″) that is most distant from the substrate (S) has a thickness (d₃) of the period (P₃) which is between 7.2 nm and 7.7 nm.

10. The mirror according to claim 1, wherein an intermediate layer or an intermediate layer arrangement is provided between the layer arrangement and the substrate (S), and serves for the stress compensation of the layer arrangement.

11. The mirror according to claim 1, wherein a metal layer having a thickness of greater than 20 nm is provided between the layer arrangement and the substrate (S).

12. The mirror according to claim 1, wherein the materials of the two individual layers (L″, H″, L′″, H′″) forming the periods (P₂, P₃) are either molybdenum and silicon or ruthenium and silicon, and wherein the individual layers are separated by at least one barrier layer (B) and the barrier layer (B) consists of a material which is selected from or as a compound is composed of the group of materials: B₄C, C, Si nitride, Si carbide, Si boride, Mo nitride, Mo carbide, Mo boride, Ru nitride, Ru carbide and Ru boride.

13. The mirror according to claim 12, wherein the barrier layer (B) comprises the material B₄C and has a thickness of between 0.35 nm and 0.8 nm.

14. The mirror according to claim 1, wherein a covering layer system (C) comprises at least one layer (M) composed of a chemically inert material and terminates the layer arrangement of the mirror.

15. The mirror according to claim 1, wherein a thickness factor of the layer arrangement along the mirror surface assumes values of between 0.9 and 1.05.

16. The mirror according to claim 15, wherein the thickness factor of the layer arrangement at a location of the mirror surface correlates with a maximum angle of incidence ensured for the radiation at that location of the mirror.

17. The mirror according to claim 1, wherein the layer arrangement comprises at least three layer subsystems (P′, P″, P′″), and wherein the transmission of EUV radiation through the at least three layer subsystems (P′, P″, P′″) is less than 10%.

18. The mirror according to claim 2, wherein the layer subsystems (P″, P′″) are constructed from the same materials for the high refractive index layer (H″, H′″) and the low refractive index layer (L″, L′″), and wherein the layer subsystem (P′″) that is most distant from the substrate (S) has a number (N₃) of periods (P₃) that is greater than the number (N₂) of periods (P₂) for the layer subsystem (P″) that is second most distant from the substrate (S).

19. The mirror according to claim 2, wherein the transmission of the EUV radiation through the layer subsystems (P″, P′ ″) of the layer arrangement is less than 2%.

20. A projection objective for microlithography comprising a mirror according to claim 1.

21. A projection exposure apparatus for microlithography comprising a projection objective according to claim 20.
